(19) United States
(12) Patent Application Publication
(10) Pub. No.: US 2026/0261994 A1
(43) Pub. Date: Sep. 3, 2026

(54) INTER-WIRELESS-DEVICE SYNCHRONIZATION METHOD, WIRELESS DEVICE, AND INTER-WIRELESS-DEVICE SYNCHRONIZATION SYSTEM

(71) Applicant: NATIONAL INSTITUTE OF INFORMATION AND COMMUNICATIONS TECHNOLOGY, Koganei-shi, Tokyo (JP)

(72) Inventors: Michiharu NAKAMURA, Tokyo (JP); Takeshi MATSUMURA, Tokyo (JP); Hirokazu SAWADA, Tokyo (JP); Chang-Woo PYO, Tokyo (JP); Masafumi MORIYAMA, Tokyo (JP)

(73) Assignee: NATIONAL INSTITUTE OF INFORMATION AND COMMUNICATIONS TECHNOLOGY, Koganei-shi, Tokyo (JP)

(21) Appl. No.: 19/474,414

(22) PCT Filed: Mar. 12, 2024
(86) PCT No.: PCT/JP2024/009494

§ 371 Date: Oct. 10, 2025

(30) Foreign Application Priority Data
Apr. 12, 2023 (JP) 2023-064752

(51) Int. Cl. H04W 56/00; H04J 3/06

(52) U.S. Cl. CPC H04W 56/0015; H04J 3/0667

(57) ABSTRACT

A method includes transmitting information relating to a precision rank of a first wireless device and information relating to a calculated propagation time from the first wireless device to a second wireless device, and transmitting information relating to a precision rank of the second wireless device and information relating to a calculated time difference from the second wireless device to the first wireless device; and calculating clock drift of synchronization timings based on the propagation time and the time difference and comparing the information relating to the precision ranks in the first wireless device and/or the second wireless device, and reducing the calculated clock drift by making a correction toward the synchronization timing with the higher precision rank that has been compared, so as to perform synchronization.

### TECHNICAL FIELD

The present invention relates to an inter-wireless-device synchronization method and an inter-wireless-device synchronization system for performing synchronization between a first wireless device and a second wireless device wirelessly communicable with one another, and a wireless device.

### BACKGROUND ART

A cellular wireless communication system that has been developed as a system that allows a voice call even while moving regardless of a location to which a telephone is connected via a telephone line is currently used not only for voice calls but also for using a wide variety of services that utilizes information communication. Furthermore, not only do humans use services with terminals at hand, but use in the industrial field such as remote operation of various sensors and industrial machines is also spreading.

On the other hand, a wireless local area network (LAN) developed for easily connecting a personal computer to a computer network at an office or home is also used when a wide variety of services utilizing information communication is used. In view of this, while the cellular wireless communication system and the wireless LAN have differences in the expansion of geographical locations where communication takes place and in contract forms to make communication available, there is no boundary from the viewpoint of using services utilizing information communication.

While the services utilizing information communication used to be achieved by transmitting and receiving short character information at the beginning, they have expanded to transmit and receive images, music data, and moving image data, in particular, in recent years, to transmit more detailed, higher image quality moving image data and virtual reality environments, and the amount of data to be communicated is continuously increasing. In addition, a demand for connecting a large number of devices at once is also increasing.

Up to the present, the cellular wireless communication system and the wireless LAN have handled an increased communication data amount by introducing a technique that uses higher-order modulation schemes, and increases the amount of data transmittable per unit frequency width of a radio wave, such as a Multi-Input Multi-Output (MIMO) channel that uses multiple antenna elements, and increasing the frequency bandwidth used by the system.

Here, the amount of data transmittable per unit frequency width of a radio wave has an upper limit corresponding to electric power of a signal, and an absolute amount of energy permitted to be radiated as a radio wave is in some cases restricted due to safety reasons and a demand for greening of the whole communication system. In addition, it is difficult to increase the amount of data transmittable per unit frequency width of a radio wave to the current state or more in a situation where electric power permitted to be consumed for communication is restricted.

Accordingly, it is necessary to increase the frequency bandwidth used by the system; however, it is difficult to newly secure a frequency band available for a cellular wireless communication system or a wireless LAN at a frequency equal to or less than approximately 6 GHz at which existing radio wave utilization systems, such as positioning or sensing by broadcasting or satellites, meteorological radars, police or fire department radios, aeronautical or ship radios, and amateur radios, concentrate.

Therefore, it has been examined to use a millimeter wave that indicates a radio wave with a frequency of approximately 10 GHz to 100 GHz, a sub-terahertz wave exceeding 100 GHz, and a terahertz wave reaching 1 THz to 10 THz for the cellular wireless communication system and the wireless LAN. 3GPP (registered trademark) has formed a cellular wireless communication standard that mainly uses a millimeter wave in the 28 GHz band, and has been partially put to practical use. IEEE has formed a technical standard, such as a wireless LAN specification 802.11ad or 802.11ay that uses the 60 GHz band, and 802.15.3d that communicates in a point-to-point manner using the 300 GHz band. With these millimeter wave, sub-terahertz wave, and terahertz wave, a substantial amount of bandwidth is available at once. For example, with the IEEE 802.11ay standard, based on the 2.16 GHz bandwidth, the 8.7 GHz bandwidth obtained by bundling four 2.16 GHz bandwidths is available, and with the 802.15.3d standard, the 69 GHz bandwidth obtained by bundling a maximum of thirty-two 2.16 GHz bandwidths is available. Such a wide bandwidth cannot be ensured at a frequency equal to or less than 10 GHz.

According to the Friis transmission formula, received power Pr at a reception end when a radio wave propagates in free space is expressed as Pr=(λ/4πd)²·Gᵣ·Gₜ·Pt_{.} λ, d, Gᵣ, Gₜ, and Pₜ are a wavelength of the radio wave, a distance between transmission and reception points, directional gain of a receiving antenna, directional gain of a transmitting antenna, and transmission electric power, respectively. Since the wavelength shortens in inverse proportion to the frequency, the received power weakens in inverse proportion to the square of the frequency. While it is known that for a propagation path that is not free space, such as inside a room and on a street, the received power statistically deviates from the inverse-square law in some cases, the fact that the received power weakens at a value close to the square of the frequency remains. Accordingly, in communication that uses a high frequency, it is necessary to compensate for a decrease in the received power by using an antenna with high directional gain at one or both of sides that mutually perform transmission and reception. The antenna with high directional gain is an antenna that radiates a radio wave in a certain direction in a concentrated manner or intensely receives a radio wave arriving from a certain direction, and on the other hand, weakens the intensity of radio waves radiated in or received from the other directions.

Most of the cellular wireless communication systems are based on a licensing system for the radio wave frequency band they use, and a permitted business operator exclusively uses a provided frequency band and establishes and operates a wireless communication system. The cellular wireless communication system specifies both individual frequency resources obtained by dividing the frequency band permitted to be used into smaller pieces and a time slot in which the frequency resource is used to use them as a radio resource, and a wireless base station provided for each specific area manages and controls the use of the radio resource in the area. On the other hand, most of the wireless LANs are used in a frequency band that does not require a license (unlicensed band), and employ a Carrier Sense Multiple Access-Collision Avoidance (CSMA-CA) method. A terminal and an access point monitor the usage condition of a radio wave in the frequency band immediately before a radio resource in which communication is to be attempted, and when it is determined that no other party is using the radio wave, the communication is made.

For the usage control of the radio resource performed by the wireless base station of the cellular wireless communication system, there are a Frequency Division Multiple Access (FDMA) method in which a downlink, which performs communication from the wireless base station to a subordinate terminal, and an uplink, which performs communication from the subordinate terminal to the wireless base station, use different frequency bands, and a Time Division Multiple Access (TDMA) method in which the downlink and the uplink are separately used for each time period by dividing a time period in the same frequency band. In any case, the wireless base station assigns an exclusive radio resource to the wireless base station itself and the subordinate terminal, and therefore, competition for a radio resource is avoidable in a range where one wireless base station controls the radio resource.

On the other hand, when adjacent wireless base stations each control radio resources, communication in a radio resource used by one wireless base station interferes with communication of the other wireless base station using the same radio resource. This has a possibility of causing a serious effect when a TDD method in which the downlink and the uplink use the same frequency band is employed as illustrated in FIG. 9. Wireless base stations 71 are usually provided at locations apart from one another on a structural body, such as a building rooftop and a utility pole, when provided outdoors, or on a wall surface near a ceiling when provided indoors, and are immobile. Even when terminals 72 move together with humans or objects, a certain physical distance is kept between the wireless base stations and the terminals. On the other hand, the terminals 72 are in some cases brought close to one another in association with the movement. In such a case, when one terminal 72a performs reception in a radio resource controlled under a certain wireless base station 71a, if another terminal 72b brought close performs transmission in the same radio resource controlled by another wireless base station 71b, strong interference is caused, and reception by the terminal 72a is interfered. This problem is avoidable by performing synchronization between the wireless base stations 71a and 71b for a time slot in which the radio resource is used for the uplink and a time slot in which the radio resource is used for the downlink, and not making the terminal 72 that performs reception and the terminal 72 that performs transmission coexist at the same timing. Also with the IEEE 802.11ay standard, a mechanism with which access points ensure the synchronization condition using a Global Navigation Satellite System (GNSS) or the like is provided, thus attempting to reduce interference between wireless communications under different access points.

When a certain terminal finds a synchronization signal of a certain wireless base station or access point, if it is unknown whether it is the optimal connection destination, it is necessary to search for a synchronization signal of another wireless base station or access point. However, when temporal synchronization is not present between the wireless base stations or the access points, and they communicate at their own respective timings, it is difficult to establish a mechanism for effectively finding another wireless base station or access point from the wireless base station or the access point that has been found first. In addition, when respective synchronization signals are received from many wireless base stations and access points, available radio resources are reduced accordingly. When temporal synchronization is present between the wireless base stations or the access points, and, for example, all the wireless base stations and the access points are set to simultaneously emit synchronization signals, the terminal can recognize the synchronization signal that has been received the earliest among the several synchronization signals received with short times differences as the synchronization signal of the wireless base station or the access point located the closest. In particular, when a radio wave with a high frequency, such as a terahertz wave, is used, it is easy to shorten the duration of a synchronization signal, and therefore, synchronization signals from a plurality of the wireless base stations and the access points in different distance relations are likely to be separated on a time axis.

It is considered that the location of the terminal can be identified, and the development of an application associated with location confirmation can be supported on the established wireless communication system if temporal synchronization of signals transmitted by the plurality of wireless base stations and access points is ensured when the terminal can receive radio waves of those wireless base stations and access points. In particular, a bandwidth exceeding 10 GHz can be ensured when a radio wave with a high frequency, such as a terahertz wave, is used, and therefore, it is considered that identifying a location with accuracy of 1 cm or less is possible. While the temporal synchronization of the wireless base stations or the access points is preferred to be synchronization with absolute time using standard time or a satellite positioning system (GNSS), as long as at least relative synchronization is locally maintained, a relative position within the local range can be identified, and therefore, this is considered to be sufficient for many applications. When it is necessary to identify global locations, combination with another conventional means, such as information obtained from IP addresses, is also considered usable.

From the several reasons described above, it is possible to say that, when the wireless communication system is established, it is preferred to ensure time synchronization between the wireless base stations or the access points. This becomes more significant when a radio wave with a high frequency, such as a terahertz wave, is used.

### CITED DOCUMENTS

### Non-Patent Literature

Non-Patent Literature 1: Nakanishi, et al., “Development and implementation of high-precision time synchronization access system” NTT Technical Journal, April, 2017

### DISCLOSURE OF THE INVENTION

### Problems to be Solved by the Invention

As one of several techniques that attempt time synchronization between base stations (access points), it is known to use Precision Time Protocol (PTP) defined in the IEEE 1588 standard as illustrated in FIG. 10 (for example, see Non-Patent Literature 1). According to this, an atomic clock or a high-precision clock source referred to as a grand master (GM) 81 including a GNSS synchronization function is provided on a network, and each of the wireless base stations 71a, 71b, as slaves, ensures time synchronization by communicating with the GM 81 or a master ensuring time synchronization with the GM 81 using PTP via the network.

In a method of the time synchronization using PTP, the GM 81 or the master transmits a Sync signal with a time stamp (t1) to the wireless base station 71 as the slave. The wireless base station 71 records time (t1′) at which the wireless base station 71 itself has received the Sync signal with the time stamp (t1). The wireless base station 71 transmits a Delay_Req signal with a time stamp (t2) of the wireless base station 71 itself to the GM 81 or the master. The GM 81 or the master transmits time (t2′) at which the Delay_Req signal with the time stamp (t2) has been received to the wireless base station 71. The wireless base station 71 can calculate that a propagation time of the signal between the wireless base station 71 itself and the GM 81 or the master is {(t1l′−t1)+(t2′−t2)}/2 and a time difference is {(t1′−t1)−(t240 −t2)}/2 from a time difference between the notified time stamps and the time of the wireless base station 71 itself, and thus, the time difference can be corrected.

In the cellular wireless communication system, a terminal that has received a synchronization signal of a wireless base station transmits a random access signal at a predetermined timing, and the wireless base station that has received the random access signal can measure a propagation time of a radio wave between the wireless base station and the terminal from a difference between transmitted time of the synchronization signal emitted by the wireless base station itself and received time of the received random access signal. Notifying the terminal of it allows the terminal to know the propagation time, and transmission in line with a timing at which the wireless base station receives the signal is possible. This corresponds to the wireless base station calculating a propagation time from a value obtained by t2′−t1 by setting t2−t1′ in the time synchronization using PTP to a predetermined known fixed value with the wireless base station being a master and the terminal being a slave. The terminal does not need the value of the time stamp, and therefore, the time stamp is not used for the synchronization signal or the random access signal.

In order to constitute a wireless system by wireless base stations synchronized using PTP defined in the IEEE 1588 standard, it is necessary to establish a backbone network using devices that support PTP, including a GM, which poses a problem of the whole expensive system.

On the other hand, a method of synchronizing another wireless base station as a slave with a wireless base station as a master needs various additional arrangements and settings, such as preliminarily setting a special master wireless base station, and a mechanism that activates an alternative master wireless base station when the master wireless base station fails, and thus, has a drawback of complicated establishment of the system and complicated operational maintenance.

Therefore, the present invention has been invented in consideration of the above-described problems, and an object of the present invention is to provide an inter-wireless-device synchronization method and synchronization system that allow performing synchronization between wireless base stations without establishing a network using devices that support the IEEE 1588 standard, thus being capable of establishing the whole wireless system at a low price.

### Solutions to the Problems

In order to solve the above-described problems, an inter-wireless-device synchronization method according to the present invention is an inter-wireless-device synchronization method for performing synchronization between a first wireless device and a second wireless device that are wirelessly communicable with one another. The method includes: transmitting a first signal from the first wireless device based on a first synchronization timing held by the first wireless device itself, transmitting a second signal from the second wireless device in response to the received first signal, and calculating a propagation time of a radio wave between the first wireless device and the second wireless device in the first wireless device that has received the second signal; calculating a relative time difference between a second synchronization timing held by the second wireless device itself and a timing at which the first signal has been received in the second wireless device; transmitting information relating to a precision rank of the first wireless device itself and information relating to the calculated propagation time from the first wireless device to the second wireless device, and transmitting information relating to a precision rank of the second wireless device itself and information relating to the calculated time difference from the second wireless device to the first wireless device; and calculating clock drift of synchronization timings based on the propagation time and the time difference mutually shared and comparing the information relating to the precision ranks in the first wireless device and/or the second wireless device, and reducing the calculated clock drift by making a correction toward the synchronization timing with the higher precision rank that has been compared, so as to perform synchronization.

Furthermore, a wireless device according to the present invention includes: propagation time calculation means that transmits a first signal based on a first synchronization timing held by the wireless device itself, and calculates a propagation time of a radio wave between the wireless device itself and another wireless device based on a second signal transmitted from the other wireless device that has received the first signal; information exchanging means that transmits information relating to a precision rank of the wireless device itself and information relating to the propagation time calculated by the propagation time calculation means to the other wireless device, and receives information relating to a precision rank of the other wireless device and information relating to a relative time difference between a second synchronization timing held by the other wireless device and a timing at which the first signal is received; and synchronization means that calculates clock drift of synchronization timings based on the propagation time calculated by the propagation time calculation means and the time difference received by the information exchanging means, compares the information relating to the precision rank of the wireless device itself and the information relating to the precision rank of the other wireless device that have been shared, and reduces the calculated clock drift by making a correction toward the synchronization timing with the higher precision rank that has been compared between the wireless device and the other wireless device, so as to performing synchronization.

A wireless device according to the present invention includes: transmitting means that, when a first signal generated based on a first synchronization timing held by another wireless device itself is received, transmits a second signal in response to the first signal; time difference calculation means that calculates a relative time difference between a second synchronization timing held by the wireless device itself and a timing at which the first signal is received; information exchanging means that receives information relating to a precision rank of the other wireless device and information relating to a propagation time of a radio wave between the wireless device and the other wireless device calculated based on the second signal transmitted by the transmitting means, and transmits information relating to a precision rank of the wireless device itself and the time difference calculated in the time difference calculation means to the other wireless device; and synchronization means that calculates clock drift of synchronization timings based on the propagation time received by the information exchanging means and the time difference calculated by the time difference calculation means, compares the information relating to the precision rank of the wireless device itself and the information relating to the precision rank of the other wireless device that have been shared, and reduces the calculated clock drift by making a correction toward the synchronization timing with the higher precision rank that has been compared between the wireless device and the other wireless device, so as to perform synchronization.

An inter-wireless-device synchronization system according to the present invention is an inter-wireless-device synchronization system for performing synchronization between a first wireless device and a second wireless device that are wirelessly communicable with one another. The synchronization system includes: propagation time calculation means that transmits a first signal from the first wireless device based on a first synchronization timing held by the first wireless device itself, transmits a second signal from the second wireless device in response to the received first signal, and calculates a propagation time of a radio wave between the first wireless device and the second wireless device in the first wireless device that has received the second signal; time difference calculation means that calculates a relative time difference between a second synchronization timing held by the second wireless device itself and a timing at which the first signal is received in the second wireless device; and information exchanging means that transmits information relating to a precision rank of the first wireless device itself and information relating to the propagation time calculated by the propagation time calculation means from the first wireless device to the second wireless device, and transmits information relating to a precision rank of the second wireless device itself and information relating to the time difference calculated by the time difference calculation means from the second wireless device to the first wireless device. The first wireless device and/or the second wireless device calculates clock drift of synchronization timings based on the propagation time and the time difference that have been mutually shared, compares the information relating to the precision ranks, and reduces the calculated clock drift by making a correction toward the synchronization timing with the higher precision rank that has been compared, so as to perform synchronization.

### Effects of the Invention

According to the present invention configured as described above, synchronization between wireless base stations is allowed to be performed without establishing a network using devices that support the IEEE 1588 standard, and thus, the whole wireless system is able to be established at a low price.

### BRIEF DESCRIPTION OF THE DRAWINGS

FIG. 1 is a drawing illustrating an overall configuration of an inter-wireless-device synchronization system to which the present invention is applied.

FIG. 2 is a block configuration diagram of a wireless device.

FIG. 3 is a timing chart when the operation of an inter-wireless-device synchronization system according to a first embodiment is executed.

FIG. 4 is a timing chart when another operation of the inter-wireless-device synchronization system according to the first embodiment is executed.

FIG. 5 is a drawing for describing the format of a message that notifies a propagation time between the wireless devices.

FIG. 6 is a drawing illustrating an example of a field that classifies precision ranks into six levels and notifies the precision ranks.

FIG. 7 is a timing chart when the operation of an inter-wireless-device synchronization system according to a second embodiment is executed.

FIG. 8 is a timing chart when the operation of an inter-wireless-device synchronization system according to a third embodiment is executed.

FIG. 9 is a drawing for describing a problem of a prior art.

FIG. 10 is a drawing illustrating an example using PTP defined in the IEEE 1588 standard as one technique of attempting time synchronization between base stations.

### DESCRIPTION OF PREFERRED EMBODIMENTS

The following describes an inter-wireless-device synchronization system to which the present invention is applied in detail with reference to the drawings.

### First Embodiment

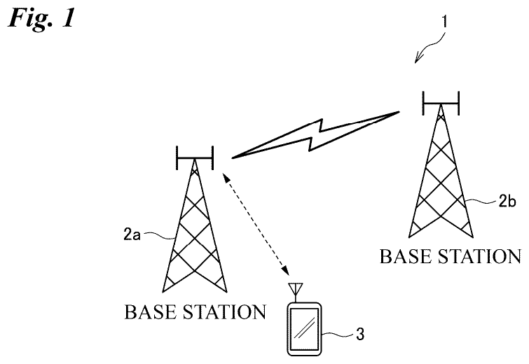

FIG. 1 is a drawing illustrating an overall configuration of an inter-wireless-device synchronization system 1 to which the present invention is applied. This synchronization system 1 includes a plurality of wireless devices 2, and a terminal 3 that wirelessly communicates between the respective wireless devices 2. While the following example describes the case where the wireless device 2 is constituted of two wireless devices 2a, 2b as an example, the wireless device 2 is not limited to this, and the example also includes the case where the wireless device 2 is constituted of three or more.

The wireless device 2 is a wireless base station of a cellular wireless communication system or an access point in a wireless LAN, and the wireless device 2 itself serves as a master and performs wireless communication with the terminal 3. The wireless device 2 is able to mutually perform wireless communication with another wireless device 2. However, this wireless device 2 is not limited to the case where it is constituted of such a wireless base station or an access point, and the wireless device 2 itself may be constituted of a smartphone, a mobile terminal, a personal computer (PC), a wearable device, or a tablet terminal.

The terminal 3 is any electronic device wirelessly communicable with the wireless device 2, and the communication location of the terminal 3 changes by the movement of a person who carries, for example, a smartphone, a mobile terminal, a mobile PC, a wearable device, or a tablet terminal.

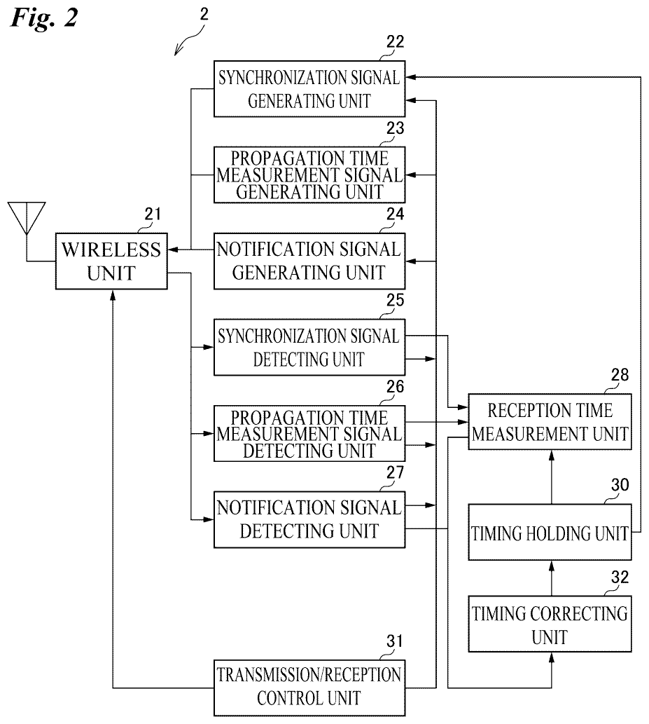

FIG. 2 is a block configuration diagram of the wireless device 2. Note that the block configuration diagram illustrated in this FIG. 2 illustrates components that are the minimum necessary for producing an expected effect of the present invention, and does not illustrate other components for operating as the wireless base station or the access point.

The wireless device 2 includes a wireless unit 21, a transmission/reception control unit 31 connected to this wireless unit 21, and a reception time measurement unit 28 connected to the transmission/reception control unit 31, and furthermore, includes a synchronization signal generating unit 22, a propagation time measurement signal generating unit 23, a notification signal generating unit 24, a synchronization signal detecting unit 25, a propagation time measurement signal detecting unit 26, and a notification signal detecting unit 27 respectively connected to these wireless unit 21, transmission/reception control unit 31, and reception time measurement unit 28. The wireless device 2 includes a timing holding unit 30 connected to the reception time measurement unit 28 and the synchronization signal generating unit 22, and a timing correcting unit 32 connected to the reception time measurement unit 28 and the timing holding unit 30.

The wireless unit 21 is constituted of an antenna necessary for performing wireless communication with the terminal 3 or another wireless device 2, a frequency conversion circuit, a modulation circuit, and a portion for executing coding or decoding. The wireless unit 21 converts signals generated by the synchronization signal generating unit 22, the propagation time measurement signal generating unit 23, and the notification signal generating unit 24 into wireless signals with radio frequencies and output levels specified by the transmission/reception control unit 31, and transmits them via the antenna. The wireless unit 21 performs a reception operation that converts a signal with the radio frequency specified by the transmission/reception control unit 31 among signals received via the antenna into a signal operatable by the synchronization signal detecting unit 25, the propagation time measurement signal detecting unit 26, and the notification signal detecting unit 27.

The synchronization signal generating unit 22 generates a synchronization signal and transmits this to the wireless unit 21. The propagation time measurement signal generating unit 23 generates a propagation time measurement signal and transmits this to the wireless unit 21. The notification signal generating unit 24 generates a notification signal and transmits this to the wireless unit 21.

The synchronization signal detecting unit 25 detects the synchronization signal from the signals received by the wireless unit 21. The propagation time measurement signal detecting unit 26 detects the propagation time measurement signal from the signals received by the wireless unit 21. The notification signal detecting unit 27 detects the notification signal from the signals received by the wireless unit 21.

The transmission/reception control unit 31 switches the wireless unit 21 between transmission and reception operations, and specifies a predetermined radio frequency and output level. The transmission/reception control unit 31 determines which signal is transmitted at which time point or which signal to detect from the signals received in the wireless unit 21. The transmission/reception control unit 31 notifies the synchronization signal generating unit 22, the propagation time measurement signal generating unit 23, the notification signal generating unit 24, the synchronization signal detecting unit 25, the propagation time measurement signal detecting unit 26, and the notification signal detecting unit 27 of the determined content and gives various instructions.

The reception time measurement unit 28 measures the time at which the synchronization signal or the propagation time measurement signal has been received.

The timing holding unit 30 notifies a timing at which the synchronization signal generated in the synchronization signal generating unit 22 is transmitted, and notifies a time reference measured by the reception time measurement unit 28.

The timing correcting unit 32 corrects the timing held by the timing holding unit 30 in accordance with the time measured by the reception time measurement unit 28 and the content of the notification detected by the notification signal detecting unit 27.

Note that the functions of the timing holding unit 30 and the timing correcting unit 32 can be taken on by the transmission/reception control unit 31. However, in the present invention, there is a case where the control of a specially precise timing is desired, which is an extremely important function, and therefore, these timing holding unit 30 and timing correcting unit 32 are independent components.

Next, the operation of the synchronization system 1 to which the present invention is applied will be described. The synchronization system 1 performs synchronization between the wireless devices 2a and 2b in a mutual manner. The wireless devices 2a, 2b each include the components illustrated in FIG. 2 described above.

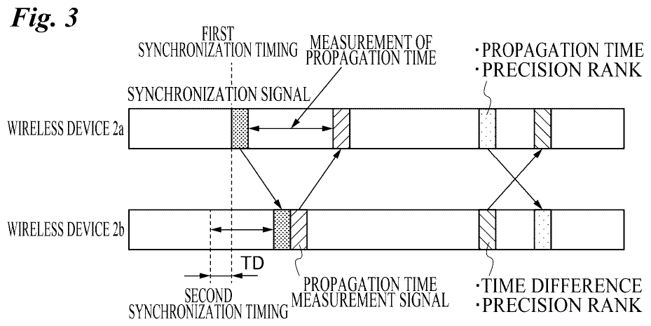

In such a case, as illustrated in FIG. 3, the wireless device 2a transmits the synchronization signal based on a first synchronization timing held by the wireless device 2a itself. In such a case, the wireless device 2a generates the synchronization signal in the synchronization signal generating unit 22 of the wireless device 2a itself under the control of the transmission/reception control unit 31, and transmits this via the wireless unit 21. The synchronization signal transmitted from the wireless device 2a is received by the wireless device 2b. At this time, the wireless device 2b receives this via the wireless unit 21 of the wireless device 2b itself, and furthermore, detects this via the synchronization signal detecting unit 25 under the control by the transmission/reception control unit 31.

Next, the wireless device 2b receives this synchronization signal, and transmits the propagation time measurement signal for responding to this to the wireless device 2a. In such a case, under the control by the transmission/reception control unit 31, the propagation time measurement signal is generated by the propagation time measurement signal generating unit 23 and this is transmitted via the wireless unit 21. At this time, the wireless device 2b may further include information relating to the reception time of the synchronization signal and the transmission time of the propagation time measurement signal in the generated propagation time measurement signal. The propagation time measurement signal transmitted from the wireless device 2b is received by the wireless device 2a. At this time, the wireless device 2a receives this via the wireless unit 21 of the wireless device 2a itself, and further detects this via the propagation time measurement signal detecting unit 26 under the control by the transmission/reception control unit 31.

The wireless device 2a calculates a propagation time after detecting the reception time of the propagation time measurement signal detected via the propagation time measurement signal detecting unit 26. At this time, the wireless device 2a calculates the propagation time based on the transmission time of the synchronization signal transmitted by the wireless device 2a itself and the reception time of the propagation time measurement signal at which the propagation time measurement signal has been detected. The calculation method for this propagation time will be described in detail later.

The wireless device 2b calculates a relative time difference between a second synchronization timing held by the wireless device 2b itself and a timing at which the synchronization signal transmitted by the wireless device 2a has been received. The calculation method for this time difference will be described in detail later.

Next, from the wireless device 2a, information relating to a precision rank of the wireless device 2a itself and information relating to the calculated propagation time are transmitted to the wireless device 2b. From the wireless device 2b, information relating to the precision rank of the wireless device 2b itself and information relating to the calculated time difference are transmitted to the wireless device 2a. This causes a state in which the information relating to the precision rank of the wireless device 2a and the calculated propagation time, and the information relating to the precision rank of the wireless device 2b and the calculated time difference are mutually exchanged and shared between the wireless device 2a and the wireless device 2b. Note that these information relating to the propagation time and information relating to the time difference to be transmitted are sometimes transmitted by, for example, being respectively encoded.

Next, the wireless device 2a and/or the wireless device 2b calculates clock drift of the synchronization timing based on each piece of information of the propagation time and the time difference mutually shared. The information relating to the precision rank of the wireless device 2a side and the information relating to the precision rank of the wireless device 2b side mutually shared are compared. A correction is then made toward the synchronization timing with the higher precision rank compared, and thus, the calculated clock drift is reduced, and synchronization is performed.

Note that, while this embodiment is constituted of the wireless device 2a that calculates the propagation time of the radio wave from the reception time of the propagation time measurement signal in response to the transmitted synchronization signal and notifies the wireless device 2b as a counterpart of the propagation time of the radio wave, and the wireless device 2b that transmits the propagation time measurement signal in response to the received synchronization signal and notifies the wireless device 2a as a counterpart of information relating to the reception time of the synchronization signal, the configuration is not limited to this. That is, the roles of the wireless device 2a and the wireless device 2b may be interchanged with one another, and the wireless device 2b side may calculate the propagation time of the radio wave from the reception time of the propagation time measurement signal in response to the transmitted synchronization signal, and notifies the wireless device 2a as a counterpart of the propagation time of the radio wave. The synchronization signal may be a signal modulated by a 1, 0 sequence. For the modulation scheme, for example, Binary Phase-Shift Keying (BPSK) or Quadrature Phase-Shift Keying (QPSK) may be used.

The wireless device 2b attempts to detect the synchronization signal in a time slot in which the synchronization signal transmitted by the wireless device 2a is considered to be receivable. The time slot in which the synchronization signal is considered to be receivable can be based on the second synchronization timing held by the wireless device 2b itself. For example, when the second synchronization timing held by the wireless device 2b itself is considered to be approximately close to the first synchronization timing of the wireless device 2a that transmits the synchronization signal, the wireless device 2b can attempt to detect the synchronization signal during a certain period of time before and after the second synchronization timing of the wireless device 2b itself. It is considered that the synchronization signal is successfully detected if the 1, 0 sequence of the same pattern as a pattern determined as the synchronization signal can be demodulated.

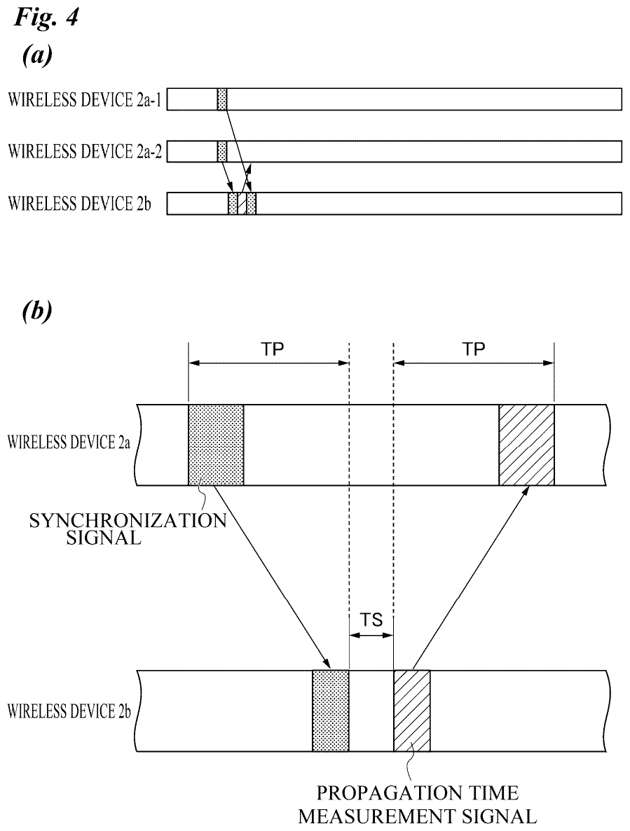

When a plurality of wireless devices 2a-1, 2a-2 are present as illustrated in FIG. 4(a), the wireless device 2b receives a plurality of synchronization signals in some cases. When the respective first synchronization timings of the plurality of wireless devices 2a-1, 2a-2 are assumed to already approximately match, the synchronization signal of the wireless device 2a-2 the closest to the wireless device 2b is received the earliest, and the wireless device 2b transmits the propagation time measurement signal in response to the synchronization signal transmitted by the wireless device 2a-2. In such a case, this propagation time measurement signal is received by the wireless device 2a-2, and the above-described propagation time is calculated by this wireless device 2a-2.

The wireless device 2b is not limited to the case of responding to the synchronization signal received the earliest, and, for example, may transmit the propagation time measurement signal in response to the synchronization signal having the highest signal strength. In such a case, regardless of the reception time point of the synchronization signal, the propagation time measurement signal is transmitted to the wireless device 2a that has transmitted the largest synchronization signal. Alternatively, a certain threshold value is preliminarily set for the signal strength of the synchronization signal, and the propagation time measurement signal may be transmitted from the wireless device 2b in response to the first synchronization signal exceeding the threshold value. As illustrated in FIG. 4(b), the wireless device 2b that has detected the synchronization signal transmits the propagation time measurement signal after the elapse of a processing time (Ts) determined after the reception of the synchronization signal. The processing time (Ts) is preferred to be 0, but in practice, signal processing from the reception of the synchronization signal to the transmission of the propagation time measurement signal often requires time. For this processing time (Ts), a preliminarily determined time may be set.

When the synchronization signal transmitted by the wireless device 2a is received by the wireless device 2b after the elapse of a propagation time (TP), the propagation time measurement signal is received by the wireless device 2a after the elapse of the same propagation time (TP) from the transmission time by the wireless device 2b. In view of this, the wireless device 2a receives the propagation time measurement signal after the elapse of 2 x TP +Ts from the transmitted time of the synchronization signal as illustrated in FIG. 4(b).

Accordingly, the wireless device 2a measures the time from the transmission of the synchronization signal to the reception of the propagation time measurement signal, and subtracting the preliminarily determined processing time (Ts) from the measured time and dividing it by two allows calculating the propagation time TP.

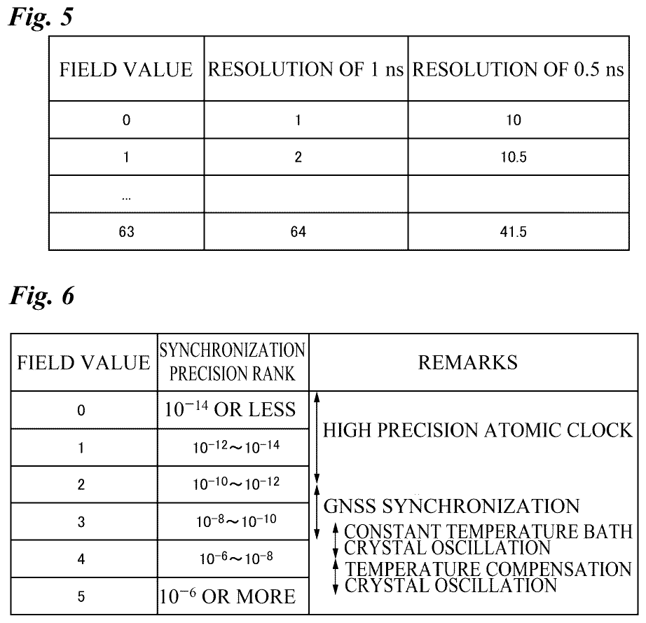

Between the wireless device 2a and the wireless device 2b, the format of a message notifying the propagation time TP is preliminarily set, and thus, the wireless device 2a notifies the wireless device 2b of the propagation time TP. For example, as illustrated in FIG. 5, setting a notification message to which a 6-bit wide field is assigned allows using numerical values of 0 to 63 to represent the propagation time from 1 ns to 64 ns with a resolution of 1 ns, or the propagation time from 10 ns to 41.5 ns with a resolution of 0.5 ns.

In the case of the former resolution of 1 ns, the relation between an information value n and the propagation time represented by the information value n is representable by TP=n+1 (ns). In the case of the latter resolution of 0.5 ns, TP=0.5×n+10 (ns).

In generating information relating to its own precision rank, each of the wireless devices 2 may determine the precision corresponding to its clock source. That is, the wireless device 2 has a high precision rank when the clock source mounted in the device of the wireless device 2 itself is a high-precision atomic clock, such as a cesium atomic clock, or when it is used as a grand master to ensure synchronization by a synchronization network that can ensure the precision. On the other hand, the precision rank is low when the wireless device 2 has no particular network synchronization and operates with the clock source by a crystal oscillator mounted in the device of the wireless device 2 itself. Even when the crystal oscillator is the clock source, the precision rank may be differentiated depending on the case where a crystal oscillator having a constant temperature bath that keeps a temperature constant is used as a source oscillator, the case where a crystal oscillator that compensates for a temperature change is used as a source oscillator, the case where a crystal oscillator without particular countermeasures for a temperature change is used as a source oscillator, or the like.

The information relating to the precision rank mutually transmitted and received between the wireless devices 2 can notify the precision ranks divided into a maximum of eight levels when, for example, a message with a field width of 3 bit is used. FIG. 6 is an example of a field that notifies the precision ranks classified into six levels. The wireless device 2b that has detected the synchronization signal transmits the propagation time measurement signal to the wireless device 2a and measures the time at which the synchronization signal has been detected using the timing of the wireless device 2b itself as a reference. This time equals the propagation time TP of the radio wave when the synchronization timings held respectively by the wireless device 2a and the wireless device 2b completely match.

On the other hand, when there is drift in TD regarding the synchronization timings between the wireless device 2a and the wireless device 2b, the reception time of the synchronization signal using the synchronization timing of the wireless device 2b as a reference is TD+TP. While this drift in the synchronization timing may be defined as + in any of the case where the synchronization timing of the wireless device itself is earlier than the synchronization timing of the counterpart or the case where the synchronization timing of the wireless device itself is later than the synchronization timing of the counterpart, the following defines the case where the synchronization timing of its own is earlier as +.

The wireless device 2b notifies the wireless device 2a of the information relating to the reception time of the synchronization signal using the synchronization timing of the wireless device 2b itself as a reference thus obtained. The reception time of the synchronization signal using the synchronization timing of the wireless device 2b itself as a reference is a relative value, and for a message used for this notification, the same kind of message as a message for the wireless device 2a having the field illustrated in FIG. 5 to notify the wireless device 2b of the propagation time of the radio wave is usable. However, the bit field width or the conversion formula of the time represented by a notified value may be different from this. When the difference between the maximum value and the minimum value of the time that should be notified is large, one or two of values used in the field of a message to be notified may be defined as the minimum value or less or the maximum value or more of a timing difference to which another value corresponds.

The wireless device 2b notifies the wireless device 2a of the information relating to the precision rank of the timing held by the wireless device 2b itself. In such a case, it is possible to use a message in the same format as the message having the field illustrated in FIG. 5 used when the wireless device 2a notifies the wireless device 2b of the information relating to the precision rank.

The wireless device 2a calculates the propagation time TP as described above, and receives a notification relating to the reception time of the synchronization signal (TD +TP) using the synchronization timing of the wireless device 2b as a reference from the wireless device 2b. The wireless device 2a then obtains the timing difference, that is, what is called the clock drift between the wireless device 2a and the wireless device 2b from the formula of propagation time (TP)−reception time (TD+TP). In the case of the above-described formula, the timing difference is −TD. Since the case where the timing of the wireless device 2a itself is earlier than the counterpart is defined as +, when the timing of the wireless device 2b is earlier than the timing of the wireless device 2a, for the wireless device 2a, the timing is later than the timing of the wireless device 2b, and therefore, the timing difference is negative.

The wireless device 2b measures the reception time of the synchronization signal (TD+TP) using the synchronization timing of the wireless device 2b itself as a reference, and obtains this by receiving the notification relating to the propagation time TP from the wireless device 2a. The wireless device 2b can obtain the value of the timing difference, that is, what is called the clock drift TD between the wireless device 2a and the wireless device 2b from the formula of reception time (TD+TP) propagation time (TP) measured by the wireless device 2b itself after obtaining the propagation time TP.

As described above, both the wireless device 2a and the wireless device 2b obtains the respective TDs, which are the values of the clock drift indicating how early the synchronization timing of itself is compared to the synchronization timing of the counterpart (negative values when it is late), and obtains the information relating to the precision ranks of both the wireless device 2a and the wireless device 2b.

The wireless device 2a and/or the wireless device 2b compares the precision ranks of itself and the other. The wireless device 2a and/or the wireless device 2b then makes a correction toward the synchronization timing with the higher precision rank that has been compared, and thus, the above-described calculated clock drift is reduced, thereby performing synchronization.

Specifically, the wireless device 2a and/or the wireless device 2b controls the synchronization timing of itself so as to adjust the synchronization timing of itself to the synchronization timing of the counterpart when the precision rank of itself is lower than the counterpart. When the precision rank of the wireless device 2a is lower than the precision rank of the wireless device 2b, the wireless device 2a delays or advances the synchronization timing held by the wireless device 2a itself by TD. This solves the clock drift TD between the wireless device 2a and the wireless device 2b, and thus their synchronization timings are successfully made the same. That is, when TD is a negative value, it is only necessary to advance the synchronization timing held by itself.

When the precision ranks are the same level between the wireless device 2a and the wireless device 2b, the synchronization timing held by itself is delayed by 1/2 of the timing difference TD. When TD is a negative value, the synchronization timing held by itself is advanced by ½ of TD. Meanwhile, when TD is a positive value, the synchronization timing held by itself is delayed by ½ of TD. That is, for a side having a delayed synchronization timing between the wireless device 2a and the wireless device 2b, the synchronization timing is advanced by ½ of TD, and for a side having an advanced synchronization timing, the synchronization timing is delayed by ½ of TD. This allows the synchronization timings to be the same between the wireless device 2a and the wireless device 2b.

However, the present invention is not necessarily limited to the case where, for the side having the delayed synchronization timing, the synchronization timing is advanced by ½ of TD, and for the side having the advanced synchronization timing, the synchronization timing is delayed by ½ of TD when the precision ranks are the same level. A timing amount to be advanced TD×μ, and a timing amount to be delayed TD×(1−μ) are not limited to μ=½, and μ may be set to any value from 0 to 1.

### Second Embodiment

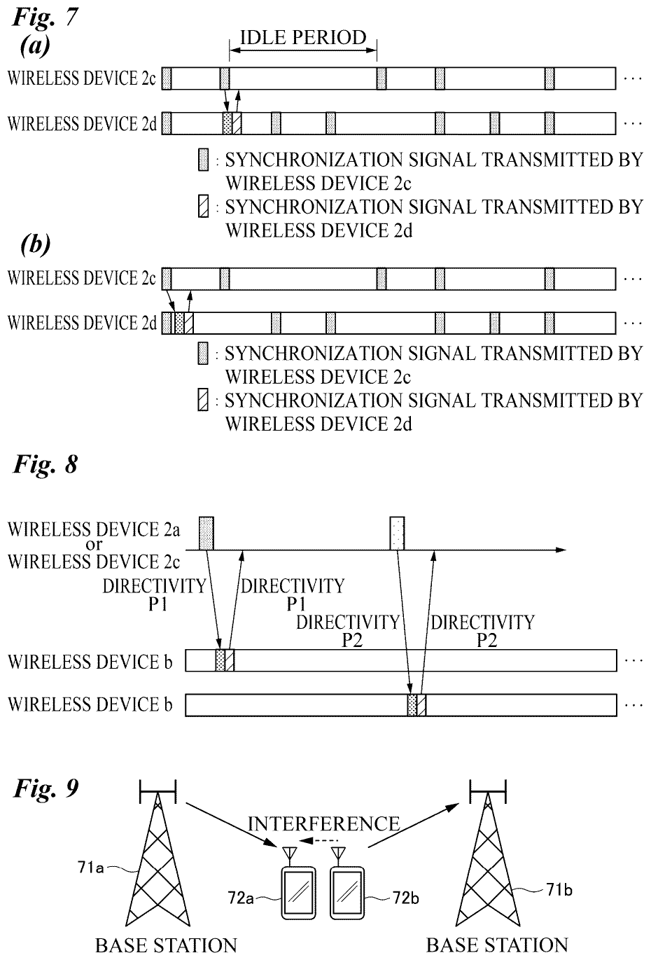

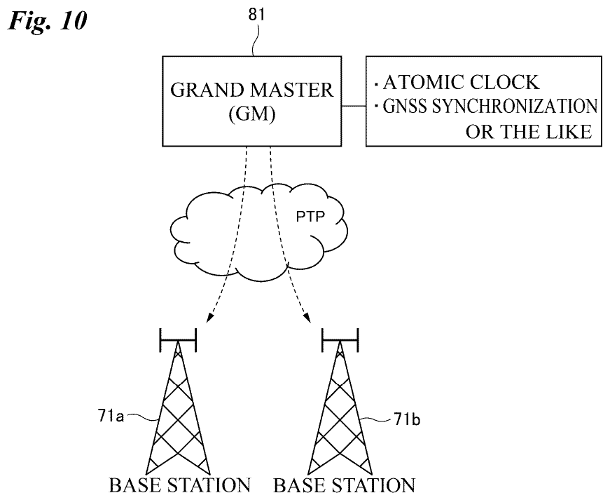

Note that, while in the first embodiment described above, there has been described the case where the wireless device 2a and the wireless device 2b take on the mutually different functions as an example, the example is not limited to this. For example, one wireless device 2c can take on both the function of the wireless device 2a and the function of the wireless device 2b in the first embodiment described above. The wireless device 2c in such a case transmits a synchronization signal at the synchronization timing held by the wireless device 2c itself similarly to the wireless device 2a as illustrated in FIG. 7. The wireless device 2c attempts to receive the synchronization signal transmitted by another wireless device 2d in the time slot in which no transmission is underway. The time slot in which the wireless device 2c attempts to receive the synchronization signal transmitted by the other wireless device 2d may be a time slot in which the transmission of the synchronization signal is temporarily stopped as illustrated in FIG. 7(a), or may be immediately after the wireless device 2c itself has transmitted the synchronization signal as illustrated in FIG. 7(b).

When the other wireless device 2d transmits the synchronization signal at approximately the same time, the synchronization signal transmitted by the other wireless device 2d can be received immediately after the synchronization signal is transmitted when the duration of the synchronization signal is shorter than the propagation time of the radio wave between the two. For example, when the wireless device 2c and the wireless device 2d are separated by 3 m or more, since the time it takes for the radio wave to propagate over a distance of 3 m is 10 ns, setting the duration of the synchronization signal to 10 ns allows receiving the synchronization signal transmitted by the other wireless device after the transmission of the synchronization signal.

Here, when the wireless device 2c receives the synchronization signal transmitted by the other wireless device 2d, correction of the held synchronization timing is possible by performing the operation as the wireless device 2b in the first embodiment described above. Alternatively, the correction of the held synchronization timing is possible by operating as the wireless device 2a in the first embodiment as it is after transmitting the synchronization signal. Whether to operate as the wireless device 2a or to operate as the wireless device 2b may be selected conveniently in the transmission/reception control unit 31. For example, it is possible to operate as the wireless device 2a immediately after transmitting the synchronization signal, thereafter, switch to the operation as the wireless device 2b when the propagation time measurement signal has not been detected within a predetermined time period, and detect the synchronization signal transmitted by the other wireless device 2d. The control that increases the proportion of operating as the wireless device 2a when the held precision rank is high, or conversely, increases the proportion of operating as the wireless device 2b when the held precision rank is low is also possible.

### Third Embodiment

The wireless device 2a and the wireless device 2b in the first embodiment or the wireless device 2c that takes on both the functions in the second embodiment are each allowed to use a directional antenna in the wireless unit 21.

In such a case, as illustrated in FIG. 8, the transmission/reception control unit 31 in the wireless device 2a or the wireless device 2c may select various kinds of transmission directivity P1, P2 for each opportunity of transmitting the synchronization signal and transmit an instruction to the wireless unit 21. When the synchronization signal is transmitted by an antenna having the certain directivity P1 from the wireless device 2a or the wireless device 2c, it is considered that the propagation time measurement signal is likely to be received from the other wireless device 2b present in that direction, and therefore, reception of the propagation time measurement signal may be attempted by the same antenna as the antenna used when the synchronization signal has been transmitted or an antenna having the same directivity P1 as that of the used antenna. Similarly, when the synchronization signal is transmitted by an antenna having the certain directivity P2 from the wireless device 2a or the wireless device 2c, reception of the propagation time measurement signal may be attempted by the same antenna as the antenna used when the synchronization signal has been transmitted or an antenna having the same directivity P2 as that of the used antenna.

Furthermore, wireless communication necessary for a notification of information relating to a propagation time, a notification of information relating to a precision rank, a notification of information relating to the reception time of a synchronization signal, and the like may be performed using the same antenna or an antenna having the same directivity as that of the used antenna. Similarly, when the wireless device 2b or the wireless device 2c in the second embodiment that performs the operation of the wireless device 2b receives the synchronization signal by an antenna having certain directivity, it is considered that the wireless device of the counterpart is likely to be present in the direction of the directivity, and therefore, the same antenna or an antenna having the same directivity may be used to perform the wireless communication necessary for transmission of a propagation time measurement signal in response thereto, transmission of a notification of information relating to the reception time of the synchronization signal, a notification of information relating to a precision rank of a timing, and the like.

### Fourth Embodiment

The wireless device 2a may transmit a notification of information relating to a precision rank prior to the transmission of the synchronization signal. Similarly, the wireless device 2b may notify information relating to a precision rank prior to the reception of the synchronization signal. Alternatively, N types of 1, 0 sequences with a known pattern are preliminarily defined, a number n is assigned to each type, and furthermore, a precision rank is associated with each of n. A plurality of n may be associated with one precision rank.

In any cases, performing such a processing operation causes the wireless device 2b that has received the synchronization signal and identified the sequence pattern to have implicitly received a notification relating to the precision rank of the wireless device 2a. Similarly, setting a plurality of sequence patterns assigned with numbers for signals used for the propagation time measurement signals causes the wireless device 2a that has received the propagation time measurement signal to have implicitly received a notification relating to the precision rank of the wireless device 2b due to the sequence pattern.

### Fifth Embodiment

When the wireless device 2a and the wireless device 2b that have obtained the information relating to the timing difference TD and the precision ranks of itself and the other correct the synchronization timings held by itself, the upper limit may be set for the correction value. That is, Max_TD is preliminarily set, and the timing difference is corrected using Max_TD (or −Max_TD) as a correction value when the timing difference that should be corrected exceeds Max_TD, and when the timing difference that should be corrected is smaller than −Max_TD when the timing difference that should be corrected is a negative value. This allows for avoiding an undetermined operation on the communication protocol that may be caused by a rapid change in the held synchronization timing while the timing difference and the clock drift are no longer able to be solved in one correction. Instead of applying Max_TD, or using in combination with the application of Max_TD, it is also possible to correct the timing difference by setting a certain coefficient μ and using μ×TD as a correction value for the timing difference TD. In the first embodiment, μ=0 when the precision rank is high, μ=1 when the precision rank is low, and μ=½ when the precision rank is the same. When the respective sums of μ are 1 in the wireless device 2a and the wireless device 2b that make a correction, one timing correction can solve the timing difference, but it is also possible to select 1 or less. For example, the sum of μ is set to 0.2 by assuming that ⅕ of the timing difference is solved in one correction, and it is possible to make a selection such that p=0.01 when the precision rank is high, μ=0.19 when the precision rank is low, and μ=0.1 when the precision rank is the same.

### DESCRIPTION OF REFERENCE SIGNS

1: Synchronization system
2: Wireless device
3: Terminal
21: Wireless unit
22: Synchronization signal generating unit
23: Propagation time measurement signal generating unit
24: Notification signal generating unit
25: Synchronization signal detecting unit
26: Propagation time measurement signal detecting unit
27: Notification signal detecting unit
28: Reception time measurement unit
30: Timing holding unit
31: Transmission/reception control unit
32: Timing correcting unit

1. An inter-wireless-device synchronization method for performing synchronization between a first wireless device and a second wireless device that are wirelessly communicable with one another, the method comprising:
transmitting a first signal from the first wireless device based on a first synchronization timing held by the first wireless device itself, transmitting a second signal from the second wireless device in response to the received first signal, and calculating a propagation time of a radio wave between the first wireless device and the second wireless device in the first wireless device that has received the second signal;
calculating a relative time difference between a second synchronization timing held by the second wireless device itself and a timing at which the first signal has been received in the second wireless device;
transmitting information relating to a precision rank of the first wireless device itself and information relating to the calculated propagation time from the first wireless device to the second wireless device, and transmitting information relating to a precision rank of the second wireless device itself and information relating to the calculated time difference from the second wireless device to the first wireless device; and
calculating clock drift of synchronization timings based on the propagation time and the time difference mutually shared and comparing the information relating to the precision ranks in the first wireless device and/or the second wireless device, and reducing the calculated clock drift by making a correction toward the synchronization timing with the higher precision rank that has been compared, so as to perform synchronization.

2. The inter-wireless-device synchronization method according to claim 1, comprising
transmitting the first signal having a time length shorter than the assumed propagation time from the first wireless device.

3. The inter-wireless-device synchronization method according to claim 1, wherein
the first signal is transmitted via an antenna having directivity and the second signal is received via the antenna or an antenna having identical directivity to the directivity in the first wireless device.

4. A wireless device comprising:
propagation time calculation means that transmits a first signal based on a first synchronization timing held by the wireless device itself, and calculates a propagation time of a radio wave between the wireless device itself and another wireless device based on a second signal transmitted from the other wireless device that has received the first signal;
information exchanging means that transmits information relating to a precision rank of the wireless device itself and information relating to the propagation time calculated by the propagation time calculation means to the other wireless device, and receives information relating to a precision rank of the other wireless device and information relating to a relative time difference between a second synchronization timing held by the other wireless device and a timing at which the first signal is received by the other wireless device; and
synchronization means that calculates clock drift of synchronization timings based on the propagation time calculated by the propagation time calculation means and the time difference received by the information exchanging means, compares the information relating to the precision rank of the wireless device itself and the information relating to the precision rank of the other wireless device that have been shared, and reduces the calculated clock drift by making a correction toward the synchronization timing with the higher precision rank that has been compared between the wireless device and the other wireless device, so as to perform synchronization.

5. A wireless device comprising:
transmitting means that, when a first signal generated based on a first synchronization timing held by another wireless device itself is received, transmits a second signal in response to the first signal;
time difference calculation means that calculates a relative time difference between a second synchronization timing held by the wireless device itself and a timing at which the first signal is received;
information exchanging means that receives information relating to a precision rank of the other wireless device and information relating to a propagation time of a radio wave between the wireless device and the other wireless device calculated based on the second signal transmitted by the transmitting means, and transmits information relating to a precision rank of the wireless device itself and information relating to the time difference calculated in the time difference calculation means to the other wireless device; and
synchronization means that calculates clock drift of synchronization timings based on the propagation time received by the information exchanging means and the time difference calculated by the time difference calculation means, compares the information relating to the precision rank of the wireless device itself and the information relating to the precision rank of the other wireless device that have been shared, and reduces the calculated clock drift by making a correction toward the synchronization timing with the higher precision rank that has been compared between the wireless device and the other wireless device, so as to perform synchronization.

6. An inter-wireless-device synchronization system for performing synchronization between a first wireless device and a second wireless device that are wirelessly communicable with one another, the synchronization system comprising:
propagation time calculation means that transmits a first signal from the first wireless device based on a first synchronization timing held by the first wireless device itself, transmits a second signal from the second wireless device in response to the received first signal, and calculates a propagation time of a radio wave between the first wireless device and the second wireless device in the first wireless device that has received the second signal;
time difference calculation means that calculates a relative time difference between a second synchronization timing held by the second wireless device itself and a timing at which the first signal is received in the second wireless device; and
information exchanging means that transmits information relating to a precision rank of the first wireless device itself and information relating to the propagation time calculated by the propagation time calculation means from the first wireless device to the second wireless device, and transmits information relating to a precision rank of the second wireless device itself and information relating to the time difference calculated by the time difference calculation means from the second wireless device to the first wireless device, wherein
the first wireless device and/or the second wireless device calculates clock drift of synchronization timings based on the propagation time and the time difference that have been mutually shared, compares the information relating to the precision ranks, and reduces the calculated clock drift by making a correction toward the synchronization timing with the higher precision rank that has been compared, so as to perform synchronization.
